(19) United States
(12) Patent Application Publication
(10) Pub. No.: US 2005/0095316 A1
(43) Pub. Date: May 5, 2005

(54) Novel method for the production of fermented dairy products by means of enzymes having a bacterial origin

(75) Inventors: Nathalie De Greeftrial, St Maximin (FR); Claire Queguiner, Fontenay aux Roses (FR); Fanny Grugier, Iffendic (FR); Denis Paquet, Clamart (FR)

Correspondence Address: NIXON & VANDERHYE, PC, 1100 N GLEBE ROAD, 8TH FLOOR, ARLINGTON, VA, 22201-4714, US

(73) Assignee: COMPAGNIE GERVAIS DANONE, Levallois-perret (FR)

(21) Appl. No.: 10/504,592

(22) PCT Filed: Jan. 17, 2003
(86) PCT No.: PCT/FR03/00152

(30) Foreign Application Priority Data
Feb. 15, 2002 (FR) 02 01961

(51) Int. Cl. A23C 9/12

(52) U.S. Cl. 426/34

(57) ABSTRACT

The invention relates to a novel method for producing fermented milk products, according to which at least one casein of the milk, i.e. at least the kappa casein, is hydrolyzed by means of a coagulating enzyme of the milk, which has a bacterial origin, and the product is stirred after fermenting. The inventive method is particularly suitable for producing fermented milk products such as yogurt and fermented types of milk, wherein said products are provided with an improved texture, especially an improved proved viscosity, without causing syneresis or generating a bad taste.

The present patent application relates to a novel method for the production of fermented dairy products which uses enzymes of bacterial origin, and in particular enzymes from bacteria which up until now were considered to be milk contaminants, and also to the novel dairy products thus obtained. This novel method is more particularly suitable for the production of yogurts and fermented milks.

It indeed has the advantage of improving the texture of such dairy products, and in particular of improving the viscosity thereof, without nevertheless inducing a phenomenon of syneresis (exudation of milk serum) which would be unacceptable for a dairy product of the yogurt or fermented milk type. Sensory analyses carried out by the inventors have also not revealed a bad taste in the yogurts and the fermented milks produced in accordance with the present invention. This notable result is, in accordance with the present invention, obtained by subjecting to proteolysis at least one milk casein, namely at least kappa-casein, and by stirring the product after fermentation. More particularly, in accordance with the present invention, this caseinolysis is carried out by means of kappa-caseinolytic enzymes of bacterial origin, and more particularly by means of kappa-caseinolytic enzymes from bacteria which were up until now considered to be milk contaminants, such as proteolytic psychotrophic bacteria and proteolytic lactic acid bacteria, and preferably thermoresistant enzymes from such bacteria.

The term “psychotrophic bacterium”, or more generally “psychotrophic microorganism”, is intended, in the present application, to mean a microorganism which is capable of growing at 7° C. or below, independently of its optimum growth temperature. This definition is that of the International Dairy Federation (IDF).

The term “thermoresistant enzyme” is intended to mean, in the present application, an enzyme which has conserved kappa-caseinolytic activity that is detectable after having undergone a thermal treatment of the pasteurization type (95° C. for at least 5 min).

To improve the texture of fermented dairy products of the yogurt or fermented milk type, the procedure is currently carried out by concentrating the milk substrate, or by adding products derived from milk, and in particular by adding proteins such as caseinate or milk serum proteins, or by adding texturizing agents (thickeners, gelling agents) such as starch, pectin or gelatin.

The proteolysis of casein in general, and of kappa-casein in particular, was not, in the prior art, a desired phenomenon during the production of fermented dairy products of the yogurt and fermented milk type. Indeed, caseinolytic enzymes, such as, for example, that which is contained in rennet, and which is used for the production of cheeses and fromages frais, were known, because of their coagulating effect, to induce substantial phenomena of syneresis. However, while the formation of whey and milk serum is sought and necessary for the production of cheeses and fromages frais (recovery of the curd), it is, on the other hand, not desirable during the production of yogurts and fermented milks, since it results in a texture which is not acceptable for this type of dairy products (granular texture, considerable exudation of milk serum). Accordingly, up until now, caseinolytic enzymes were not used during the production of yogurts and fermented milks, and care was even taken to avoid such enzymes being present or produced in the milk substrate.

The development of contaminating microorganisms, such as psychotrophic bacteria and lactic acid bacteria, was not, moreover, a phenomenon that was sought during the production of dairy products in general, and of yogurts and fermented milks in particular, either.

Lactic acid bacteria, i.e. all the bacteria which produce lactic acid from sugars, and more particularly from lactose, are ubiquitous bacteria which contaminate milk at the time it is collected and which, if they are allowed to multiply, cause the milk to curdle.

Accordingly, for many years, systems for refrigerating the milk right from the sight of collection (usual storage at 4° C. on the farm), and prepasteurization of the milk as soon as it arrives at the factory, have been set up in order to thus avoid the milk clotting before it is converted into a dairy product of food quality.

Psychotrophic bacteria are also ubiquitous bacteria. They are found in particular at the surface of the teat, where they represent 95% of the total flora (3% of them being Pseudomonas). Contact of the milk with such sources can then result in contamination with psychotrophic bacteria. The critical phase of milk contamination therefore most commonly occurs when the automated milking is carried out. Now, during refrigerated storage which is carried out in order to avoid in particular the development of lactic acid bacteria, the psychotrophic bacteria are, for their part, under conditions favorable for their development. This is, for example, the case of Pseudomonas, which, in milk at 4° C., have a generation time of 6 to 8 hours. During their growth, these bacteria synthesize thermoresistant lipases and proteases which are known to be the cause of alterations in the milk and dairy products. Such microorganisms were therefore considered to constitute a conventional microbiological contamination of milk, which it was necessary to avoid.

Thus, Gassem and Franck 1991 (“Physical properties of yogurt made from milk treated with proteolytic enzymes”, J. Dairy Sci. 74:1503-1511) describe trials carried out in the presence of partially purified proteases from psychotrophic bacteria (dose of 200 mg/liter) and report that the yogurts thus produced have an apparent viscosity and a firmness that are greater than the control yogurts, but that they exhibit greater syneresis. The authors conclude by recommending that proteolytic activities should be limited as much as possible during the production of yogurts.

Cousin and Marth 1977 (“Cottage Cheese and Yoghurt Manufactured from Milks Precultured with Psychotrophic Bacteria” Cultured Dairy Products Journal, May 1977, pages 15-18 and 30) have, for their part, described trials in which milk was inoculated with psychotrophic bacteria (1% inoculation with a culture, on skimmed milk for 24 h at 21° C., of psychotrophic bacteria of the Pseudomonas or Flavobacterium genus). On this occasion, they noted an increase in the tension of the curd when the milk is stored at 4° C., but independently of whether or not there was inoculation with psychotrophic bacteria. In addition, the sensory analyses showed that the yogurts made with the inoculated milk are judged to be more acid and bitter. The authors therefore conclude that to produce fermented dairy products, it is recommended to avoid the development of psychotrophic bacteria in the fresh milk.

The proteolysis of milk was therefore considered in the prior art as a source of technological problems and of defects in milk and dairy products, such as the formation of a fragile curd accompanied by syneresis during the production of yogurts (Tamine & Robinson 1985, “Yoghurt—Science and Technology”, Ed. Woodhead Publishing Ltd 1999, cf. page 17), and gelling of milk during UHT heat treatment (Stephaniak & Sorhaug 1995, Thermal denaturation of bacterial enzymes in milk. International dairy federation bulletin “Heat induced changes in milk”, 1, p. 349-363).

By going completely against the technical prejudices of the prior art, the inventors for their part, propose, in order to produce fermented dairy products of the yogurt and fermented milk type, not only to proteolyze at least one of the caseins naturally present in milk, namely at least kappa-casein, and to stir the product obtained after fermentation, but also to perform this caseinolysis by means of kappa-caseinolytic enzymes of bacterial origin, and in particular by means of kappa-caseinolytic enzymes from bacteria which up until now were considered to be microorganisms that contaminated milk, such as proteolytic psychotrophic bacteria and proteolytic lactic acid bacteria. The inventors have indeed demonstrated that it is in fact advantageous to use kappa-caseinolytic enzymes to produce fermented milks and yogurts, and preferably kappa-caseinolytic enzymes of bacterial origin, and that the “milk-contaminating” bacteria such as proteolytic psychotrophic bacteria and proteolytic lactic acid bacteria constitute an advantageous source thereof. According to a preferred embodiment, in accordance with the present invention, use is made of thermoresistant kappa-caseinolytic enzymes of bacterial origin, i.e. enzymes which have conserved kappa-caseinolytic activity that is detectable after having undergone a heat treatment of the pasteurization type (95° C. for at least 5 min).

The inventors have demonstrated that these means make it possible, surprisingly and unexpectedly, to improve the texture, and in particular the viscosity, of yogurts and fermented milks, without as a result inducing syneresis, which would be unacceptable for a product of this type (no exudation or settling out).

The sensory analyses carried out by the inventors have also revealed no bad taste in the products produced in accordance with the present invention.

The present patent application is therefore directed toward a novel method for the production of fermented dairy products, and in particular of yogurts and fermented milks, characterized in that it comprises the following steps:
a milk substrate whose protein content is different from zero, but less than or equal to 6%, is subjected to lactic acid fermentation and to kappa caseinolysis so as to obtain, at the end of lactic acid fermentation, a degree of kappa caseinolysis equal to or greater than 20%, preferably equal to or greater than 30%, more preferably equal to or greater than 40%, even more preferably equal to or greater than 50%, and in that
said substrate is stirred after lactic acid fermentation and kappa-caseinolytic treatment.

In the present application, the terms “yogurts” and “fermented milks” have their usual meanings. More particularly, these names correspond to those defined in France by decree No. 88-1203 of Dec. 30, 1988 (published in the official journal of the French Republic of Dec. 31, 1988). The text of this decree is reproduced below, at the end of the description, following the examples.

To obtain a “yogurt or fermented milk” product as defined in the French decree, and therefore as referred to in the present patent application, it is in particular recalled that there must not be elimination of milk serum and that there must be a heat treatment at least equivalent to pasteurization. A standard pasteurization treatment is, for example, a treatment at 92-95° C. for 5 to 10 minutes. Because of the application of a heat treatment which is at least equivalent to standard pasteurization, the milk serum proteins of the milk substrate are denaturated overall (from 25 to 99% of them, approximately).

The term “kappa caseinolysis” or “kappa-caseinolytic treatment” is here intended to mean proteolysis of kappa-casein. Similarly, the term “kappa-caseinolytic enzyme” refers to an enzyme capable of proteolyzing kappa-casein.

Advantageously, said kappa-caseinolysis occurs at least partly concomitantly with said lactic acid fermentation. As presented in greater detail below, said kappa-caseinolytic enzyme may be added or supplied (or its production initiated) after said heat treatment (for example at the beginning of or during the lactic acid fermentation), or else before or at the beginning of said heat treatment, but in the latter case, care should be taken not to induce precipitation during this heat treatment.

As milk naturally contains kappa-caseins and naturally has a protein content different from zero, any type of milk substrate is a priori suitable for carrying out the present invention. There will of course nevertheless be chosen a milk substrate which, insofar as it is intended for the production of yogurts and fermented milks, has a protein content (before fermentation) of less than or equal to 6%. Preferably, a milk substrate will be chosen whose protein content is between 3 and 5%, limits inclusive, more preferably between 3.4 and 5%, even more preferably between 3.6 and 4.8%. A conventional method for measuring the protein content of a milk substrate consists in measuring the total nitrogen content, and in subtracting the nonprotein nitrogen content using the Kjeldahl method described in “Science du lait—Principes des techniques laitières” [Milk science—principles of dairy techniques], fourth edition, 1984, by C. Alais (publisher SEPAIC), pages 195-196.

The term “milk substrate” is here intended to have its usual meaning for the production of fermented dairy products of the yogurt and fermented milk type, i.e. any type of substrate the composition of which is suitable for carrying out a lactic acid fermentation for the purpose of producing yogurts and fermented milks suitable for human consumption. Generally, the milk substrate used in fact corresponds to milk as collected (for example cow's milk, ewe's milk, goat's milk) which has been optionally pasteurized and/or skimmed. Most generally, and in particular in industry, the composition of milk is also “standardized” by the addition of milk-derived products such as skimmed milk powder and/or dairy protein powders (caseinates or WPC) and/or fats (cream for example). The milk substrates referred to for the present invention therefore in fact most generally have a composition which corresponds either to that of milk as collected, or to that of standardized milk, and may have been prepasteurized (at 75° C. for 10 to 30 s) and/or skimmed.

The novel method in accordance with the invention can be carried out for any lactic acid fermentation. The steps of a method for lactic acid fermentation may be conventionally schematically presented as follows:
after collection, the milk is generally prepasteurized at 75° C. for 10 to 30 seconds, skimmed and stored until use by refrigerated storage,
the skimmed milk is standardized in relation to proteins by methods known to those skilled in the art, in particular by the addition of skimmed milk powder, dairy protein powders (caseinates or WPC) and, optionally, in relation to fat (for example cream), so as to obtain the desired composition,
after rehydration of the powders with stirring for 30 min to 1 hour, the milk mixture thus obtained is subjected to a pasteurization heat treatment at a temperature of 92 to 95° C. for 5 to 10 min, and then to homogenization under pressure referred to as “descending phase”; alternatively, the homogenization may be carried out before the heat treatment, it is then referred to as “ascending phase”,
the milk mixture is then cooled to a temperature 1 or 2 degrees higher than that for fermentation, and is inoculated with a lactic acid ferment; the fermentation is carried out according to conventional procedures, it is stopped at a pH of between 4 and 5, preferably between 4.5 and 4.7.

When the milk mixture is inoculated with a ferment made up of strains of Lactobacillus bulgaricus and of Streptococcus thermophilus, the product is a yogurt. When the milk mixture is, in addition to the preceding strains, inoculated with other species of lactic acid bacteria, in particular Bifidobacterium, Lactobacillus acidophilus, Lactobacillus casei or Lactobacillus helveticus, the finished product is a fermented milk.

The kappa-caseinolysis should be carried out in a controlled manner, i.e. the primary proteolytic reaction should not consist in hydrolyzing the casein into its various constituent amino acids, but in hydrolyzing the casein into fragments of peptide, polypeptide or protein size. This does not of course exclude these fragments from being able, once produced by the controlled kappa-caseinolysis, to then be further modified and/or hydrolyzed during the process. Initially, however, the kappa-caseinolysis which is carried out in accordance with the present invention results in the release of at least one peptide, polypeptide or protein fragment, and not in a set of individual amino acids. For this, use will be made, in accordance with the present invention, of a kappa-caseinolytic agent which moreover has the property of coagulating milk, i.e. the property of destabilizing the micelle, and therefore inducing coagulation of the milk. The expression “coagulation of the milk” is here intended to mean flocculation or precipitation. A conventional method for determining whether an agent has the property of coagulating milk is the Berridge test (standard 176:1996 of the International Dairy Federation, 41, square Vergote, B-1040 Brussels), or the modified Berridge test (without addition of CaCl₂ to the milk tested).

By way of illustration, such agents generally release, from the kappa-casein, at least one fragment the size of which is less than or equal to 10 kDa, preferably less than or equal to 8 kDa.

To carry out a kappa-caseinolysis in a food medium, a kappa-caseinolytic enzyme is advantageously used. To carry out a controlled kappa-caseinolysis, as indicated above, at least one kappa-caseinolytic enzyme which has the property of coagulating milk (coagulating kappa-caseinolytic enzyme) will preferably be chosen.

In accordance with the present invention, at least one coagulating kappa-caseinolytic enzyme which is of bacterial origin will be chosen. Bacteria which are advantageous for the production of such enzymes comprise in particular bacteria which, up until now, were considered to be milk contaminants, and whose development and metabolism it was, up until now thought to limit.

Such bacteria comprise in particular milk-contaminating proteolytic psychotrophic bacteria, many examples of which will be found in Robin C. Mc Kelar, 1989, “Enzymes of psychrotrophs in raw food”, publisher CRC Press: all the proteases of psychotrophic bacteria which are known to date are coagulating kappa-caseinolytic enzymes, and are therefore suitable for carrying out the invention. The proteolytic psychotrophic bacteria generally produce these enzymes at the end of exponential growth, at the beginning of the stationary phase. By way of examples of such bacteria, mention may in particular be made of:
aerobic/microaerophilic Gram-negative bacteria,—such as those of the family Pseudomonadaceae (for example, the Pseudomonas genus, such as Pseudomonas chlororaphis (for example ATCC 13985), Pseudomonas fluorescens, Pseudomonas fragi (for example ATCC 4973)), such as those of the Acetobacter genus, of the Flavobacterium genus, of the Cytophaga genus, of the Alcaligenes genus, of the Achromobacter genus;
facultative anaerobic Gram-negative bacteria, such as those of the family Enterobacteriacae (for example, the Enterobacter genus and the Serratia genus) and the Aeromonas genus,
nonsporulated Gram-positive bacteria (for example, the Streptococcus genus; the Lactobacillus genus; the Micrococcus genus; the Staphylococcus genus; the Corynebacterium genus; the Microbacterium genus),
endosporulated Gram-positive bacteria (the Bacillus genus; the Clostridium genus).

Among the proteolytic lactic acid bacteria, such as bacteria of the Streptococcus or Lactobacillus genus, bacteria which produce coagulating kappa-caseinolytic enzymes are in fact found.

The term “proteolytic bacterium” is understood to mean, in the present application, a bacterium which, when it develops in milk, hydrolyzes proteins and in particular caseins, which results, in this milk, in a release of peptides compared to the control milk.

Those skilled in the art can, case by case, verify whether a given strain indeed produces a coagulating kappa-caseinolytic enzyme. It is sufficient to place the candidate strain on a substrate containing kappa-casein, and then to verify whether there is then hydrolysis of this casein, and whether the enzyme produced by this strain (extracted from biomass or from the culture of this strain) indeed has the property of coagulating milk (abovementioned Berridge test).

Preferably, as indicated above, a coagulating kappa-caseinolytic enzyme of bacterial origin which cleaves at least kappa-casein and most commonly other caseins will be chosen.

Even more preferably, a coagulating kappa-caseinolytic enzyme of bacterial origin which is thermoresistant (i.e. which always exhibits kappa-caseinolytic activity that is detectable after having been subjected to 95° C. for at least 5 min) will be chosen.

In accordance with the present invention, the kappa-caseinolytic enzyme can be provided in pure or partially purified form, or in the form of a biological extract or of an extract of a microbiological culture containing such an enzyme, such as a protein extract of microbiological culture medium. The kappa-caseinolytic enzyme can also be provided in the form of an enzymatic source such as, for example, a microorganism producing such an enzyme, which will be directly added to the milk substrate and placed under conditions favorable to its metabolism, such that this microorganism synthesizes the coagulating kappa-caseinolytic enzymes.

Coagulating kappa-caseinolytic enzymes of bacterial origin are commercially available, for example the enzyme EC 3.4.24.33 sold by Roche Diagnostics GmbH under the reference endoproteinase Asp-N “sequencing grade” Cat-No.: 1054589, the enzyme EC 3.4.21.62 Carlsberg sold by Sigma under the name subtilisin and under the reference P5380.

Alternatively, the coagulating kappa-caseinolytic enzymes can be purified from the bacterial culture medium according to a method such as those described by Robert K. Scopes (Robert K. Scopes, 1987, published by Springer-Verlag, “Protein purification. Principles and Practice”, Second Edition). It is also possible to choose not to completely purify the enzyme, and to use a biological extract of the bacteria, or a protein extract of bacterial culture medium.

It is also possible to choose to supply the milk substrate with the enzyme-producing bacteria themselves.

It is also possible, of course, to choose to genetically transform host cells, for example bacteria such as E. coli or yeasts such as S. cerevisae or Pichia pastoris, such that they produce, and preferably hyper-produce, such enzymes (cf. “Current Protocols in Molecular Biology”, J. Wiley and Sons, 1994, publisher Frederick M. Ausubel, Roger Brent, Robert E. Kingston, David D. Moore, J. G. Seidman, Kevin Struhl). It is then possible to choose either to supply the milk substrate with a biological extract of these clones or a protein extract of their culture medium, or else to prepurify the cloned proteases in order to supply them to the milk substrate in pure form.

The kappa-caseinolysis step is not necessarily a step distinct from that of the lactic acid fermentation: the kappa-caseinolysis step can also be generated by the lactic acid ferments. As an alternative, or in addition to the addition of suitable enzymes or of a source of suitable enzymes, it is in fact possible to choose to carry out the kappa-caseinolysis using lactic acid bacteria which produce (either naturally or after genetic transformation) such enzymes, while at the same time performing their lactic acid ferment function.

Preferably, it will be chosen to add a thermoresistant enzyme or a source of thermoresistant enzyme (which will conserve kappa-caseinolytic activity that is detectable after having been subjected to 95° C. for at least 5 min), such as the protease of Pseudomonas fragi ATCC 4973.

The choice of the form in which the kappa-caseinolytic enzyme is added and of the moment at which it is added to the milk substrate depend of course on the temperature and pH conditions for this substrate. It is in fact possible to choose to add the enzyme, or to trigger the production thereof, at any moment of the production process between the moment at which the milk is collected and the end of the lactic acid fermentation, for example after the skimming and prepasteurization step which is generally carried out on the collected milk, during the refrigeration step, during the standardization of the milk, or else after the pasteurization, for example during cooling, inoculation of the lactic acid ferments, or during the lactic acid fermentation. It is therefore necessary to choose an enzyme which is active within the range of pH and within the range of temperature of the substrate in question during the process. Those skilled in the art will preferably choose, for a better yield, pH and temperature values which correspond to the pH and temperature values for optimum activity of the enzyme.

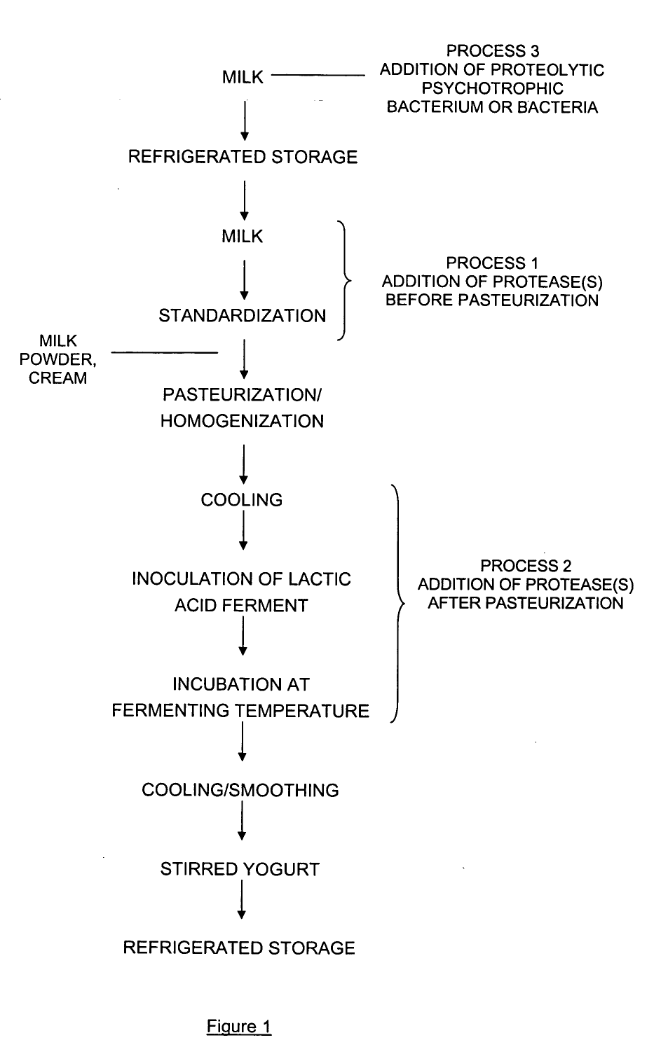

The attached FIG. 1 shows, diagrammatically, a method for the production of fermented milks and yogurts, and indicates therein, by way of illustration, some steps during which it may be chosen, in accordance with the present invention, to add proteases and/or proteolytic microorganisms. When the enzymes used are thermoresistant, they can be added before pasteurization, for example during the step known as standardization of the milk (“process 1” in FIG. 1), or else during the storage of the milk in a refrigerated environment (“process 3” in FIG. 1).

When the enzymes are provided in the form of enzyme-producing microorganisms, it is of course preferable to add these microorganisms before or during a step during which the milk is placed under conditions, and in particular temperature and pH conditions, favorable to their metabolism, and in particular favorable to the production of proteases.

The appropriate dose of enzymes to be added or, where appropriate, to be produced, depends, for its part of course, on the casein content, and in particular on the kappa-casein content of the substrate, and also on the activity of the enzyme at the chosen pH and temperature.

In accordance with the present invention it is necessary to obtain a degree of kappa-caseinolysis of at least 20%. This 20% degree is a minimum threshold, but higher degrees (up to 100%) are preferred. It should, however, be noted that, when the kappa-caseinolysis is carried out before pasteurization, it is advantageous to limit the degree of kappa-caseinolysis to less than or equal to 70% before pasteurization, in order to avoid precipitation phenomena during the pasteurization.

Using kappa-caseinolytic enzymes of bacterial origin, the inventors have noted that, in addition to the expected kappa-caseinolysis, proteolysis of other caseins, and in particular proteolysis of beta- and alpha-caseins, occurred. The introduction of kappa-caseinolytic enzymes of bacterial origin into the milk substrate therefore induces kappa-caseinolysis which is generally accompanied by beta- and/or alpha-caseinolyses. In these circumstances, and still in the interest of avoiding precipitation phenomena during pasteurization, it is preferable to limit the degree of each of the concomitant caseinolyses (alpha- and beta-caseinolyses) to less than or equal to 70% before pasteurization, when the enzyme is added to the milk substrate before pasteurization.

To measure the degree of kappa-caseinolysis in a milk substrate, those skilled in the art have standard techniques available to them, such as, for example, the electrophoretic method described by Recio et al. 1997 (“Application of electrophoresis to the study of proteolysis of caseins”, J. Dairy Res. 64:221-230). The degree of kappa-caseinolysis, can thus be evaluated by measuring the decrease in surface area of the kappa-casein peak observed after enzymatic treatment, compared to the surface area of the kappa-casein peak observed before enzymatic treatment. It should be noted that, at the end of the method according to the invention, not all the kappa-casein fragments which were produced by kappa-caseinolysis are generally visualized by this electrophoretic method (it is likely that these fragments are in fact used by the growing lactic acid ferments). Accordingly, it is recommended to monitor the decrease in the kappa-casein peak, rather than the appearance of kappa-casein fragments.

Those skilled in the art will be able to carry out the adjustments necessary for each specific case under consideration in order to achieve the desired degree of caseinolysis.

When it is excreting proteolytic psychotrophic bacteria which are added to the milk before pasteurization, it will thus be possible, for example, to add thereto a dose of 10⁴ to 10⁶ bacteria per ml, approximately, and to conserve the milk thus inoculated under conditions favorable to the metabolism of these microorganisms (temperatures of 4° C. to 15° C. approximately), for a sufficiently long period of time to allow the release into this milk of the kappa-caseinolytic enzymes, which generally occurs when the bacterial population is between 10⁶ and 10¹⁰ bacteria per ml, preferably between 10⁷ and 10⁹ bacteria per ml.

In addition to the kappa-caseinolysis, the method according to the invention comprises stirring of the fermented product. This stirring can be carried out according to conventional techniques, such as smoothing by passing through a filter (“Yoghurt science and Technology”, by A. Y. Tamine and R. K. Robinson, publisher Woodhead Publishing Ltd. 1999).

The method according to the invention has the advantage of allowing the production of fermented dairy products of the yogurt and fermented milk type, the texture of which is improved compared to yogurts and fermented milks produced in a comparable manner, but without kappa-caseinolysis to a degree of at least 20% and/or without stirring. It makes it possible in particular to produce yogurts and fermented milks whose apparent viscosity (as measured at 64 s⁻¹, 10 s at 10° C. on a coaxial cylinder viscosimeter) is increased by 20 to 70% compared to controlled yogurts and fermented milks.

The method according to the invention therefore makes it possible to limit, or even avoid, the addition of texturizing agents (such as gelatin, starch or pectin), which is currently carried out in order to confer the appropriate texture on products of the fermented milk and yogurt type. It also makes it possible to limit the protein content of the milk substrate used: the milk substrate may have a lower protein concentration while preserving a satisfactory apparent viscosity result. For example, the inventors have been able to demonstrate that, in order to achieve the apparent viscosity value which is obtained by applying the method according to the invention to a milk mixture containing 4.1% of proteins, it will be necessary, in the absence of kappa-caseinolytic treatment, to increase the protein content of the milk substrate to 4.6%. With the method according to the invention, the production of dairy products of the yogurt and fermented milk type requires a smaller amount of texturizing agents and proteins for an equivalent result in terms of texture.

In a particularly notable manner, the method according to the invention does not result in phenomena of syneresis which would be unacceptable for a product of the fermented milk or yogurt type. Thus, the inventors have been able to note the absence of any phenomenon of settling out or of exudation, even after storage for 28 days at 10° C. The products obtained have and also conserve a completely smooth and homogeneous texture, and do not have a bad taste.

The present application also relates to the fermented milks and yogurts which can be obtained by means of the method according to the invention. The fermented milks and yogurts obtained by means of the method according to the present invention are in particular characterized by a kappa-casein content which is substantially less than the kappa-casein content normally observed in the comparable products of the prior art. When they are derived from milk or milk substrate which has undergone a heat treatment at least equivalent to standard pasteurization (for example, 5-10 min at 92-95° C.), the milk serum proteins of the finished product are denatured overall (from 25 to 99% of milk serum proteins denatured, approximately). More particularly, the yogurts and fermented milks according to the invention are characterized by a percentage of kappa-caseinolysis of at least 20%, preferably of at least 30%, more preferably of at least 40%, even more preferably of at least 50%. This percentage of kappa-caseinolysis can be evaluated by capillary electrophoresis according to the method of Recio et al. 1997 (“Application of electrophoresis to the study of proteolysis of caseins”, J. Dairy Res. 64:221-230), using the fact that the surface area of the kappa-casein peak decreases during the production of the yogurts and the fermented milks prepared according to the method of the invention, and with reference to a standard peak, such as the peak for a reference compound whose content does not vary significantly in the course of the method. For example, the beta-lactoglobulin peak may be used as standard peak. The following calculation therefore makes it possible to evaluate the degree of kappa-caseinolysis of a fermented milk prepared according to the method of the invention:
Degree (%) of kappa-caseinolysis=(1−((a_{κe}*a_{βlgc}/a_{βlge})/a_{κc}))*100
With:
a_{κe}=area of the kappa-casein peak for the yogurt sample
a_{κc}=area of the kappa-casein peak for a control milk
a_{βlge}=area of the peak for the reference compound for the yogurt sample (beta-lactoglobulin peak)
a_{βlgc}=area of the reference compound for a control milk (beta-lactoglobulin peak)

The term “control milk” is intended to mean a bulk-blended milk which has been skimmed and pasteurized at a temperature of 92 to 95° C. for 5 to 10 minutes.

Such a yogurt or fermented milk also generally contains the kappa-caseinolytic enzymes of bacterial origin which has been used for the kappa-caseinolysis.

Alternatively, if the significant presence of a kappa-caseinolytic enzyme is detected in a yogurt or a fermented milk, it can be deduced therefrom that this yogurt or fermented milk is in accordance with the present invention. The significant presence of such enzymes can be determined by means of a zymogram of the casein SDS-Page type as described by C. E. Fajardo-Lira and S. S. Nielsen, 1998 (“Effect of psychrotrophic microorganisms on the plasmin system in milk”, J. Dairy Sci. 81:901-908), applied directly to proteases other than plasmin. This zymogram will have to be compared with that obtained with a sample of culture in fresh milk of the lactic acid ferments of the product, in order to identify any protease not originating from the lactic acid ferments.

Those skilled in the art will find, in the book “Yoghurt—Science and Technology”, 2nd edition, by A. Y. Tamine and R. K. Robinson (Woodhead Publishing Ltd), the content of which is entirely incorporated into the present application by way of reference, a source of valuable technical information for carrying out the embodiments of the invention.

The examples which follow are given purely by way of illustration.

### EXAMPLE 1

Bulk-blending milk obtained from direct collection by producers is prepasteurized and skimmed and then inoculated with various doses of proteolytic extract.

This proteolytic extract is obtained by precipitation of the proteins in the culture medium from Pseudomonas chlororaphis ATCC 13985. The proteolytic activity is 200 units per ml. This activity is obtained by means of the azocasein test (Kohlmann, K. L., Nielsen, S. S., Steenson, L. R., and Ladisch, M. R. 1991. “Production of proteases by psychrotrophic microorganisms”, J. Dairy Sci. 74:3275-3283). One unit represents an increase of 0.01 in the absorbence at 366 nm per hour of incubation.

These inoculated milks can be stored at 4° C. for a few hours, on the condition that the casein proteolysis thresholds, critical for the heat treatment (maximum threshold of 70% for kappa-casein, threshold of 50% for beta-casein), are not exceeded.

Stirred yogurts are prepared with these inoculated milks and the same milk that had not been inoculated. For each trial, the milk is standardized with respect to proteins and with respect to fat by means of skimmed milk powder and of cream in order to obtain a milk substrate comprising 4.5% of protein and 3.2% of fat. The composition of this milk substrate is then controlled by measuring the protein content and fat content (“Determination de la teneur en matières grasses: méthode d'extraction éthéro-chlorhydrique” [Determination of fat content: method of ethero-hydrochloric extraction] NF V04215—Official Journal of September 1969).

The milk substrate thus prepared is subjected to pasteurization (95° C.-8 min) and then to homogenization (250 bar, 2 effects). After cooling to 44° C., the milk substrate is inoculated with a lactic acid ferment and then fermented at 43° C. The “decurdling” pH (4.65) is reached after 4 h 30 min (+/−15 min) for the 4 trials. The product is then smoothed and cooled to 20° C. on a platform comprising a feed pump, a filter (350 μm mesh) then a plate cooler. It is then packaged in 125 ml pots.

Viscosity and exudation measurements are carried out on the 4 products during the refrigeration storage. The results are summarized in table 1 below. The means of 4 measurements are given with the corresponding standard deviations.

TABLE 1
Viscosity and exudation measurements carried
out during refrigeration storage on the yogurts
corresponding to the various trials

| Dose of | | | | | Exudation |
|---|---|---|---|---|---|
| proteolytic | Storage | Viscosity | Viscosity | Viscosity | (g milk |
| extract | time | D + 1 | D + 14 | D + 28 | serum/100 g |
| (ml/1 L) | (hours) | (mPa · s) | (mPa · s) | (mPa · s) | of product) |
| 0 | 0 | 1125 ± 17 | 1160 ± 33 | 1173 ± 23 | 0 |
| 10 | 20 | 1285 ± 12 | 1297 ± 9 | 1268 ± 11 | 0 |
| 10 | 0 | 1248 ± 5 | 1237 ± 6 | 1270 ± 10 | 0 |
| 20 | 0 | 1430 ± 14 | 1393 ± 23 | 1430 ± 17 | 0 |

These results demonstrate a considerable increase in viscosity in relation to the dose of proteolytic extract added to the milk. A short refrigerated storage of the milk after addition of the dose of enzymatic extract does not appear to have a substantial influence on the product. The products exhibited no settling out and no exudation.

### EXAMPLE 2

Bulk-blended milk is prepasteurized and skimmed, then inoculated with Pseudomonas fragi ATCC 4973, and then stored at 4° C. for 7 days. The milk, inoculated with 2×10⁴ bacteria per ml, has a bacterial load of 6×10⁹ psychrotrophs per ml after 7 days of storage. The evolution of proteolysis of the beta- and kappa-caseins of these milks was measured by capillary electrophoresis. The surface area of the kappa-casein peak decreased by 25% and the sum of the surface areas of the beta-casein peaks by 35%. Part of the proteolysis of the beta-casein is probably due to plasmin.

Stirred yogurts (of the Velouté type) are prepared from this inoculated milk stored for 7 days, from a non-inoculated milk stored for 7 days, and from the inoculated, unstored control milk, according to the same method as that described in example 1. The “decurdling” pH (pH 4.7) is reached after 5 h of incubation at 43° C. for the product prepared from the control milk and after 4 h 30 min for the product prepared from the proteolyzed milk.

The means of 4 viscosity measurements are presented in table 2, with the corresponding standard deviations, along with the means of the settling-out and exudation measurements.

TABLE 2
Viscosity and exudation measurements carried
out during the refrigerated storage on products
incubated for 0 and 7 days at 4° C. with
Pseudomonas fragi.

| Storage | Viscosity | Viscosity | Viscosity | Exudation |
|---|---|---|---|---|
| time | D + 1 | D + 14 | D + 28 | (g milk serum/ |
| (days) | (mPa · s) | (mPa · s) | (mPa · s) | 100 g of product) |
| 0 | 1100 ± 20 | 1088 ± 25 | 1073 ± 26 | 0 ± 0 |
| 7 not | 1124 ± 20 | 1033 ± 22 | 1104 ± 24 | 0 ± 0 |
| inoculated | | | | |
| 7 | 1510 ± 22 | 1498 ± 22 | 1600 ± 22 | 0 ± 0 |

These results demonstrate a very substantial increase in viscosity independent of the physiochemical effect of storing the milk (of the order of 40%). The products exhibited no settling out and no exudation.

### EXAMPLE 3

In this example, the bulk-blended milk prepasteurized and skimmed beforehand underwent no storage, and no proteolytic psychotrophic strain was added. Stirred yogurts were prepared according to the same method as that described in example 1. At the time of inoculation with the lactic acid ferments, small amounts of proteases from psychotrophic bacteria were added to the milk substrate (see table 3 below). The other steps of the preparation method are unchanged.

The proteases are purified from the cultures of several proteolytic psychotrophic bacteria (ATCC 13985 from example 1, and ATCC4973 from example 2). The proteolytic extract used in this example is a mixture of proteases whose proteolytic activity is 600 units per ml. This activity is obtained by means of the azocasein test (cf. example 1).

The means of the viscosity, settling-out and exudation measurements carried out on the products are given in table 3.

TABLE 3
Viscosity and exudation measurements carried
out during the refrigerated storage on the stirred
yogurts

| | | | | Exudation |
|---|---|---|---|---|
| Proteolytic | Viscosity | Viscosity | Viscosity | (g milk serum/ |
| extract | D + 1 | D + 14 | D + 28 | 100 g of |
| (mL/1 L) | (mPa · s) | (mPa · s) | (mPa · s) | product) |
| 0 | 1078 ± 10 | 1067 ± 38 | 1095 ± 40 | 0 |
| 1 | 1388 ± 15 | 1368 ± 28 | 1395 ± 62 | 0 |
| 2.5 | 1568 ± 26 | 1493 ± 21 | 1525 ± 24 | 0 |
| 5.0 | 1598 ± 7 | 1625 ± 24 | 1560 ± 18 | 0 |

Considerable increases in viscosity observed for all the doses of proteolytic extract tested.

### EXAMPLE 4

Low-fat stirred yogurts are prepared with a bulk-blended, prepasteurized skimmed milk inoculated with a proteolytic extract of Pseudomonas fragi ATCC 4973, and the same milk that had not been inoculated. This proteolytic extract of Pseudomonas fragi is obtained in the same way as the extract of Pseudomonas chlororaphis of example 1, and has a proteolytic activity of 400 units per ml.

The milk is standardized with respect to protein using skimmed milk powder in order to obtain a milk substrate comprising 4.9% of protein. The composition of this substrate is then controlled by measuring the protein content (NF V04215, cf. example 1).

The substrate thus prepared is subjected to pasteurization (95° C.-8 min) and then to homogenization (150 bar, 2 effects). After cooling to 42° C., the substrate is inoculated with a lactic acid ferment and then fermented at 40° C. The “decurdling” pH (4.70) is reached after 5 h (+/−15 min) for the 2 trials. The product is then smoothed and cooled at 20° C. on a platform comprising a feed pump, a filter (350 μm mesh) then a plate cooler. It is then packaged in 125 ml pots.

Viscosity and exudation measurements are carried out on the products during the refrigerated storage. The results are summarized in table 4 below. The means of 4 measurements are given with the corresponding standard deviations:

TABLE 4
Viscosity and exudation measurements carried
out during the refrigerated storage on the yogurts
corresponding to the various trials.

| Dose of | | | | | Exudation |
|---|---|---|---|---|---|
| proteolytic | Storage | Viscosity | Viscosity | Viscosity | (g milk |
| extract | time | D + 1 | D + 14 | D + 28 | serum/100 g |
| (ml/1 L) | (hours) | (mPa · s) | (mPa · s) | (mPa · s) | of product) |
| 0 | 0 | 980 ± 19 | 1040 ± 23 | 1063 ± 26 | 0.5 |
| 30 | 0 | 1230 ± 14 | 1285 ± 20 | 1291 ± 15 | 0 |

This example shows that a considerable increase in the viscosity can be obtained on fat-free products. The products exhibited no settling out and a small amount of exudation at D+28.

### Decree No. 88-1203 of Dec. 30, 1988 Decree Relating to Fermented Milks and to Yogurt NOR:ECOC8800150D

The prime minister,
on the report of the minister of state, minister of economic affairs, finance and the budget, lord chancellor, minister for justice, minister of agriculture and forestry, and minister for solidarity, health and social welfare, government spokesperson,
in the matter of the law of Aug. 1, 1905 on fraud and misrepresentation concerning products or services, and in particular its article 11, together with the amended decree of Jan. 22, 1919 taken for application of said law;
in the matter of the law of Jun. 29, 1934 relating to the protection of dairy products;
in the matter of the law of Jul. 2, 1935 designed for the organization and improvement of the milk market;
in the matter of the amended decree of Apr. 15, 1912 applying the abovementioned law of Aug. 1, 1905 as regards foodstuffs;
in the matter of the amended decree of Mar. 25, 1924 applying the law of Aug. 1, 1905 as regards milk and dairy products;
in the matter of decree No. 84-1147 of Dec. 7, 1984 applying the abovementioned law of Aug. 1, 1905 as regards the labeling and presentation of foodstuffs;
having had the Counsel of State (Department of Finance),

### Article 1

The name “fermented milk” is reserved for the dairy product prepared with skimmed or unskimmed milks or skimmed or unskimmed, concentrated or powdered milks, enriched or not enriched with milk constituents, which has been subjected to heat treatment at least equivalent to pasteurization, inoculated with microorganisms belonging to the species that is or are characteristic of each product.

The coagulation of fermented milks should not be obtained by means other than those which result from the activity of the microorganisms used.

The amount of free lactic acid which they contain should not be less than 0.6 gram per 100 grams at the time of sale to the consumer, and the protein content expressed in relation to the milk-containing portion should not be less than that of a normal milk.

Fermented milks should be kept, up to the time of sale to the consumer, at a temperature capable of preventing them spoiling and which will be set by a joint order of the ministers responsible for agriculture, health and consumer affairs.

### Article 2

The name “yogurt” is reserved for the fermented milk obtained, according to fair and traditional practices, by the development of specific thermophilic lactic acid bacteria only, called Lactobacillus bulgaricus and Streptococcus thermophilus, which must be inoculated simultaneously and be live in the finished product, at a rate of at least 10 million bacteria per gram expressed in relation to the milk-containing portion.

The amount of free lactic acid contained in the yogurt should not be less than 0.7 gram per 100 grams at the time of sale to the consumer.

### Article 3

Fermented milks may be supplemented with the following products: flavor extracts, natural flavorings and, within a limit of 30% by weight of the finished product, sugars and other foodstuffs which confer a specific flavor.

The incorporation, as substitute products for fats and proteins of non-milk origin, is forbidden.

They must not be subjected to any treatment that allows a constituent component of the milk used to be removed, in particular draining of the coagulum.

Orders issued in the forms provided for in the 1st article of the abovementioned decree of Apr. 15, 1912 set the list and the conditions for use of the other substances and of the other categories of flavorings authorized for the production and the preparation of the products defined in the present decree.

### Article 4

Amended by Decree 97-298 1997-03-27 Art. 2 JORF [Official Journal of the French Republic] Apr. 3, 1997

The labeling of fermented milks comprises, in addition to the information provided for by articles R. 112-6 to R. 112-31 of the abovementioned consumer code:
in addition to the trade name, information on the animal species from which the milk is derived, when it is not cow's milk;
the note “store at . . . ” followed by information on the temperature to be observed;
the note “low-fat” following the trade name if the fat content of the product, calculated on the milk-containing portion, is less than 1 percent by weight;
depending on the case, the note “sweetened” or the name of the flavoring material used if the fermented milk is sweetened or flavored;
in the event of the addition of one or more of the ingredients provided for in article 3, a note mentioning this or these ingredient(s) must be attached to the trade name.

The labeling of fermented milks may contain the note “fat”, accompanying the trade name, if the fat content, calculated on the milk-containing portion, is at least equal to 3 percent by weight.

### Article 5

The name “yogurt” may only appear on the label for a foodstuff if the product in question contains “yogurt” in accordance with the definition provided for in article 2 above.

### Article 6

A joint order of the ministers responsible for agriculture, health and consumer affairs sets, where appropriate, the period of time during which the products defined in the present decree conserve their specific properties.

### Article 7

Amended by Decree 97-298 1997-03-27 Art. 2 JORF [Official Journal of the French Republic] Apr. 3, 1997

Independently of the measures provided for the investigation and possible establishment of fraud offences in application of articles R. 215-1 to R. 215-15 of the consumer code, the microbiological characteristics of the fermented milks and the modalities for checking these characteristics are set by a joint order of the ministers responsible for agriculture, health and consumer affairs.

### Article 8

### [*Amending Article(s)*]

### Article 9

The minister of state, minister for economic affairs, finance and the budget, lord chancellor, minister for justice, minister of agriculture and forestry, minister for solidarity, health and social welfare, government spokesperson, and the secretary of state to the ministry of state, minister of economic affairs, finance and the budget, responsible for consumer affairs, are each, as applied to them, responsible for implementing the present decree, which will be published in the Official Journal of the French Republic.

1. A method for the production of a dairy product chosen from the group consisting of fermented milks and yogurts, characterized in that:
a milk substrate whose protein content is different from zero, but less than or equal to 6%, is subjected to a heat treatment at least equivalent to pasteurization, to lactic acid fermentation and to kappa-caseinolysis by means of at least one enzyme chosen from the group of kappa-caseinolytic enzymes of bacterial origin which have the property of coagulating milk, so as to obtain, at the end of lactic acid fermentation, a degree of kappa-caseinolysis equal to or greater than 20%, said kappa-caseinolysis being initiated between the collection of the milk and the end of the lactic acid fermentation, provided that, if it is initiated before said heat treatment, care is then taken not to induce precipitation during this heat treatment, and in that:
said substrate is stirred after lactic acid fermentation and kappa-caseinolytic treatment.

2. The method as claimed in claim 1, characterized in that the protein content of the milk substrate is between 3 and 5%, limits inclusive.

3. The method as claimed in claim 1, characterized in that the degree of kappa-caseinolysis is equal to or greater than 30%.

4. The method as claimed in claim 1, characterized in that the degree of kappa-caseinolysis is equal to or greater than 40%, preferably equal to or greater than 50%.

5. The method as claimed in claim 1, characterized in that said coagulating kappa caseinolytic enzyme of bacterial origin is provided in pure or partially purified form, in the form of a biological extract or of a protein extract of microbiological culture medium, or in the form of a microorganism producing such an enzyme.

6. The method as claimed in claim 2, characterized in that said coagulating kappa-caseinolytic enzyme of bacterial origin is or was produced by a bacterium chosen from the group of proteolytic lactic acid bacteria and proteolytic psychotrophic bacteria.

7. The method as claimed in claim 1, characterized in that said coagulating kappa caseinolytic enzyme of bacterial origin is or was produced by a proteolytic psychotrophic bacterium chosen from the Pseudomonas genus.

8. The method as claimed in claim 7, characterized in that said coagulating kappa-caseinolytic enzyme of bacterial origin is or was produced by a proteolytic psychotrophic bacterium chosen from the group consisting of the species Pseudomonas chlororaphis, Pseudomonas fluroescens and Pseudomonas fragi.

9. The method as claimed in claim 1, characterized in that said coagulating kappa-caseinolytic enzyme of bacterial origin is or was produced by a proteolytic lactic acid bacterium chosen from the group of bacteria of the Streptococcus and Lactobacillus genera.

10. The method as claimed in claim 1, characterized in that said coagulating kappa caseinolytic enzyme of bacterial origin has the property of conserving kappa-caseinolytic activity that is detectable after having undergone a heat treatment at 95° C. for at least 5 mm.

11. The method as claimed in claim 10, characterized in that said coagulating kappa-caseinolytic enzyme of bacterial origin is introduced before said heat treatment.

12. The method as claimed in claim 10, characterized in that, before said heat treatment, the degree of kappa-caseinolysis is less than 70%, and the degrees of alpha and beta-caseinolysis are each less than or equal to 70%.

13. The method as claimed in claim 10, characterized in that said coagulating kappa caseinolytic enzyme of bacterial origin is introduced into the milk substrate in the form of bacteria producing this enzyme, before or during a step of refrigerated storage of the milk.

14. The method as claimed in claim 10, characterized in that said coagulating kappa caseinolytic enzyme of bacterial origin is introduced into the milk substrate at the time of a milk standardization step, in the form of a pure enzyme, or
in the form of a biological extract or of a protein extract of microbiological culture medium.

15. The use of an enzyme chosen from the group of kappa-caseinolytic enzymes of bacterial origin which have the property of coagulating milk, for the production, by heat treatment at least equivalent to pasteurization, by lactic acid fermentation and by kappa-caseinolysis, of a stirred dairy product chosen from the group consisting of fermented milks and yogurts, said kappa-caseinolysis being initiated between the collection of the milk and the end of the lactic acid fermentation, provided that, if it is initiated before said heat treatment, care is then taken not to induce precipitation during this heat treatment.

16. A stirred dairy product chosen from the group consisting of fermented milks and yogurts, characterized in that its degree of kappa-caseinolysis is greater than or equal to 20% compared with fresh milk, and in that it comprises kappa-caseinolytic enzymes of bacterial origin.

17. A stirred dairy product chosen from the group consisting of fermented milks and yogurts, which can be obtained by means of the method as claimed in claim 1.
